(19) United States
(12) Patent Application Publication
(10) Pub. No.: US 2014/0115723 A1
(43) Pub. Date: Apr. 24, 2014

(54) System and Method for Digital Media Distribution

(71) Applicants: Muralidhar Kothapalli, Chandler, AZ (US); Deydeep Kothapalli, Chandler, AZ (US); Shardul Kothapalli, Chandler, AZ (US)

(72) Inventors: Muralidhar Kothapalli, Chandler, AZ (US); Deydeep Kothapalli, Chandler, AZ (US); Shardul Kothapalli, Chandler, AZ (US)

(21) Appl. No.: 13/655,359

(22) Filed: Oct. 18, 2012

(51) Int. Cl. G06F 21/10

(52) U.S. Cl. CPC G06F 21/10
USPC 726/29

(57) ABSTRACT

The present invention comprises a digital media delivery system with a physical authorization device for downloading media files to a digital media player. The physical authorization device is most preferably an indicia-bearing card, containing at least one of an NFC circuit with the NFC circuit comprising a reusable media authorization code, and/or a Quick Response code with a reusable media authorization code embedded in the QR code, and/or an eye-legible version of the reusable media authorization code. By touching or tapping the indicia-bearing card on the NFC enabled media player, or scanning the QR code, or entering the eye-legible media authorization code from the authorization device into a digital media player, the reusable media authorization code is transmitted to a file server on the Internet via an application on the digital media player and one or more media files will be downloaded to the digital media player or otherwise enabled for accessing on the digital media player. Once downloaded to the digital media player or otherwise enabled, the user may access the downloaded media file(s).

### BACKGROUND OF THE INVENTION

1. Technical Field

The present invention relates generally to the field of music and more specifically relates to systems and methods for music distribution.

2. Background Art

Various forms of entertainment, including digital media, can be an important part of everyday life for many people. Young and old, and everyone in between, watch movies and TV, listen to music, and read books almost every day. The music industry alone is estimated to be worth hundreds of billions of dollars as music is created and distributed to listeners around the world. Musicians and music publishers are always looking for new and innovative ways to get the music to the listeners and music delivery systems and methods have changed over the years as technological advances have provided new distribution channels.

For example, the gradual evolution of media delivery systems from traditional vinyl records, cassettes, and compact disks (“CDs”) has continued with the emergence and growth of 100% digital music delivery systems. Various digital file formats, such as MP3, AIFF, WAV, it is now possible to purchase and download digital versions of music to many handheld devices. Cell phones and portable music players are readily available and digital music files are available over the Internet from multiple sources. In addition, digital music streaming services like Pandora®, Spotify®, and GrooveShark® have also entered the scene and found broad acceptance with many music consumers.

While digital downloads and digital music streaming services are popular, there are certain drawbacks associated with the current digital music distribution services. For example, in order to purchase music from many online music sources, you need a credit card. Without a credit card, it may be difficult to purchase digital music from certain digital music sources. One alternative is to purchase a “gift card” for digital music from a physical retail location. The gift card will contain a code that can be “redeemed” online to obtain the desired music.

Further, while digital music streaming options are popular with many listeners, there are still limitations. For example, with most digital music streaming services, you must pay a monthly fee or listen to advertisements or your ability to play the music stream on your device will be terminated. Additionally, many music-streaming services control the order of songs played and the choice of music is typically restricted to genres and artists, without many options for customizing the music content. This is not desirable for many music listeners who prefer to have greater control over their music library and prefer to have a license to listen to the music on their own terms.

Additionally, the ability to share music has been somewhat diminished by the advent of digital media distribution. In the past, people would buy record books, DVDs, record albums, cassette tapes, or CDs and share and trade them with friends. This allowed people to share new artists and albums with friends in a social context. As digital music has become increasingly popular, this type of sharing has been greatly diminished because the opportunities for sharing digital media are at least partially constrained by technology limitations such as digital rights management (“DRM”).

As discussed herein, digital delivery is a convenient and popular way to obtain and consume various forms of media including books, music, magazines, newspapers, etc. However, the drawbacks associated with the delivery and distribution of digital media files can be difficult and limiting in a number of aspects. Accordingly, without additional enhancements and options for distribution, delivery, and consumption of digital media files, the overall experience for many media consumers will continue to be sub-optimal.

### BRIEF SUMMARY OF THE INVENTION

The present invention comprises a digital media delivery system with a physical authorization device for downloading media files to a digital media player. The physical authorization device is most preferably an indicia-bearing card, containing at least one of an NFC circuit with the NFC circuit comprising a reusable media authorization code, and/or a Quick Response code with a reusable media authorization code embedded in the QR code, and/or an eye-legible version of the reusable media authorization code. By touching or tapping the indicia-bearing card on the NFC enabled media player, or scanning the QR code, or entering the eye-legible media authorization code from the authorization device into a digital media player, the reusable media authorization code is transmitted to a file server on the Internet via an application on the digital media player and one or more media files will be downloaded to the digital media player or otherwise enabled for accessing on the digital media player. Once downloaded to the digital media player or otherwise enabled, the user may access the downloaded media file(s).

### BRIEF DESCRIPTION OF THE FIGURES

The preferred embodiments of the present invention will hereinafter be described in conjunction with the appended drawings, wherein like designations denote like elements, and:

FIG. 1 is a schematic diagram of a digital media distribution system 100 for providing digital media downloads in accordance with a preferred exemplary embodiment of the present invention;

FIG. 2 is a block diagram of a server used for implementing a digital media distribution system for providing digital media downloads in accordance with a preferred exemplary embodiment of the present invention;

FIG. 3 is a block diagram illustrating a physical authorization device for use in conjunction with a digital media distribution system for providing digital media downloads in accordance with a preferred exemplary embodiment of the present invention;

FIG. 4 is an exploded view of a physical authorization device for use in conjunction with a digital media distribution system for providing digital media downloads in accordance with a preferred exemplary embodiment of the present invention;

FIG. 5 is a flowchart for a method of distributing digital media files from a digital media server to a digital media player in accordance with a preferred exemplary embodiment of the present invention;

FIG. 6 is a flowchart for a method of requesting and receiving digital media files from a digital media server for use in conjunction with a digital media player in accordance with a preferred exemplary embodiment of the present invention;

FIG. 7 is a block diagram of a collection of media files stored in a database on a digital media server for delivery to one or more digital media players in accordance with a preferred exemplary embodiment of the present invention; and

FIG. 8 is a schematic diagram of a QR sticker suitable for use in conjunction with a preferred exemplary embodiment of the present invention.

### DETAILED DESCRIPTION OF THE INVENTION

The present invention comprises a digital media delivery system with a physical authorization device for downloading media files to a digital media player. The physical authorization device is most preferably an indicia-bearing card, containing at least one of an NFC circuit with the NFC circuit comprising a reusable media authorization code, and/or a Quick Response code with a reusable media authorization code embedded in the QR code, and/or an eye-legible version of the reusable media authorization code. By touching or tapping the indicia-bearing card on the NFC enabled media player, or scanning the QR code, or entering the eye-legible media authorization code from the authorization device into a digital media player, the reusable media authorization code is transmitted to a file server on the Internet via an application on the digital media player and one or more media files will be downloaded to the digital media player or otherwise enabled for accessing on the digital media player. Once downloaded to the digital media player or otherwise enabled, the user may access the downloaded media file(s).

This approach to distributing digital media will reintroduce several aspects to the media consumer experience. For example, users will be able to collect physical objects that represent the media they consume. The buying, selling and trading aspects and other social aspects of media consumption will be reintroduced to those who consume media using the various preferred embodiments of the present invention.

Additionally, the use of a physical authorization device means that, must like a physical book, record, DVD, CD and other physical media, illegal or unauthorized distribution may be greatly reduced. Even though the digital media may be stored on the digital media player, it cannot be accessed without the physical authorization device. Additionally, if the physical authorization device is transferred and used with a new digital media player, the digital media file associated with that physical authorization device will be marked for deletion on the first digital media player.

Further, the use of a physical authorization device will allow for a person to give a media file to another person and the person receiving the gift will be able to use the physical authorization device to access the digital media gift. Similarly, with the inclusion of custom artwork, advertisements, and other indicia printed on the physical authorization device, digital media consumers will be motivated to use the physical authorization device as a collectible item or even as a trading card or business card. For example independent (“indie”) artists without access to traditional music publishing channels, will be able to promote their music by distributing physical authorization devices to their fans and prospective fans. This will allow them to quickly and easily distribute their music without investing in the expense of traditional media distribution channels.

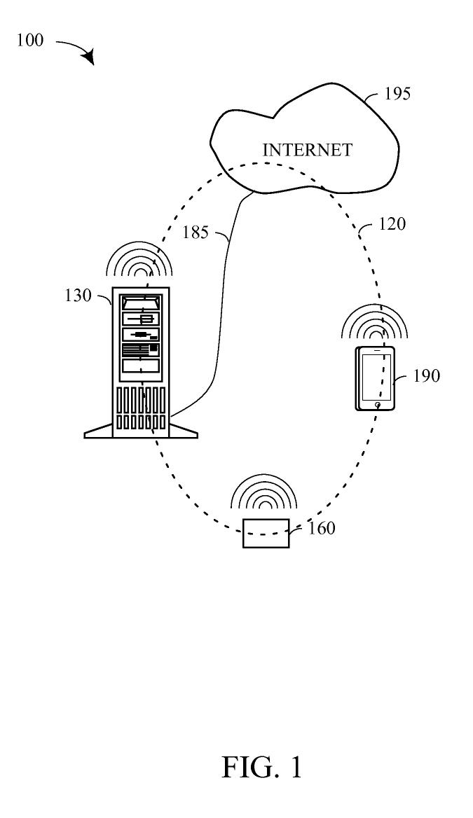

Referring now to FIG. 1, a computer-based system for providing customizable communication 100 in accordance with a preferred exemplary embodiment of the present invention comprises: a digital media server 130; a physical authorization device 160, and digital media player 190 all connected or coupled via a local area network 120 to the Internet 195 via an Internet connection 185.

Taken together, the components of digital media distribution system 100 provide a platform for the distribution of digital media files in a variety of forms. In the most preferred embodiments of the present invention, digital media distribution system 100 is configured as a system that will be used to identify and provide convenient and simplified access to digital media files for consumers of digital media. It should be noted that as used herein a digital media file may be a single music file, an album, a music playlist, a music video, a book, a collection of books, a TV show, a complete season of a TV show, a movie, a digital magazine or magazine article, etc. The contents of each media file will be defined by the artist or music publisher and be accessible only via a unique reusable media authorization code.

Network 120 represents any suitable computer communication link or similar communication mechanism, including some combination of a hardwired connection, an internal or external bus, a connection for telephone access via a modem, standard co-axial cable lines, high-speed T1 line, radio, infrared or other wireless communication methodologies (i.e. “Bluetooth,” infrared (IR), etc.), private or proprietary local area networks (LANs) and wide area networks (WANs), as well as standard computer network communications over Internet 195 or an internal network (e.g. “intranet”) via a wired or wireless connection, or any other suitable connection between computers and computer components known to those skilled in the art, whether currently known or developed in the future. It should be noted that portions of network 120 might suitably include a dial-up phone connection, a broadcast cable transmission line, a Digital Subscriber Line (DSL), an ISDN line, or similar public utility-like access link.

In the most preferred embodiments of the present invention, at least a portion of network 120 comprises a standard Internet connection 185 between at least some of the components of digital media distribution system 100 for providing access to additional network resources and other remote locations. Network 120 provides for communication between the various components of digital media distribution system 100 and allows for relevant information to be transmitted from device to device.

In the most preferred embodiments of the present invention, network 120 is configured to provide relatively high-speed transmission of textual information, audio and video data and signals, and also comprises at least an Internet connection 185 for transmission of data. Regardless of the specific components, physical nature, and topology, network 120 serves to logically and communicatively link the physical components of digital media distribution system 100, thereby enabling communication between the components.

Media server 130 represents a relatively powerful computer system that is used to provide access to digital media files via the Internet and network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with digital media server 130. Media server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of digital media server 130 may be provided by many standard, readily available data servers. This may also include the deployment of multiple inter-connected and redundant digital media servers 130 to enhance the availability and reliability of the functions provided by digital media server 130. Depending on the desired size and relative power required for digital media server 130, storage area network (SAN) technology may also be deployed in certain preferred embodiments of the present invention.

Digital media player 190 is representative of any type of NFC enabled device that is capable of accessing and playing digital media files. This includes, for example, digital media players such as NFC enabled mobile phones and tablets (e.g., Android®OS devices, Apple® iOS Devices®, Windows OS®, BlackBerry®, etc.) and other various types of smartphones and dedicated digital media players. Those skilled in the art will recognize these various devices and others that are suitable for deployment as phone 190. Digital media player 190 may also be configured to wirelessly communicate with digital media server 130 via network 120 to send and retrieve tracking and messaging services related information to and from digital media server 130. In the most preferred embodiments of the present invention, an customized application or “app” loaded on digital media player 190 will be used to communicate with digital media server 130.

In the most preferred embodiments of the present invention, each digital media player 190 will have a device identification code associated with it. For example, the device identification code may be the device International Mobile Equipment Identity (“IMEI”) number for a digital media player or the Integrated Circuit Card ID (“ICCID”) number for the Subscriber Identity Module (“SIM”) card associated with the digital media player. Alternatively, the device identification code may be a unique userid and password combination for the digital media player. This will allow for each digital media file to be associated with a single digital media player only and prevent multiple digital media players from accessing the same digital media file unless the artist or publisher has provided for simultaneous access by multiple digital media players.

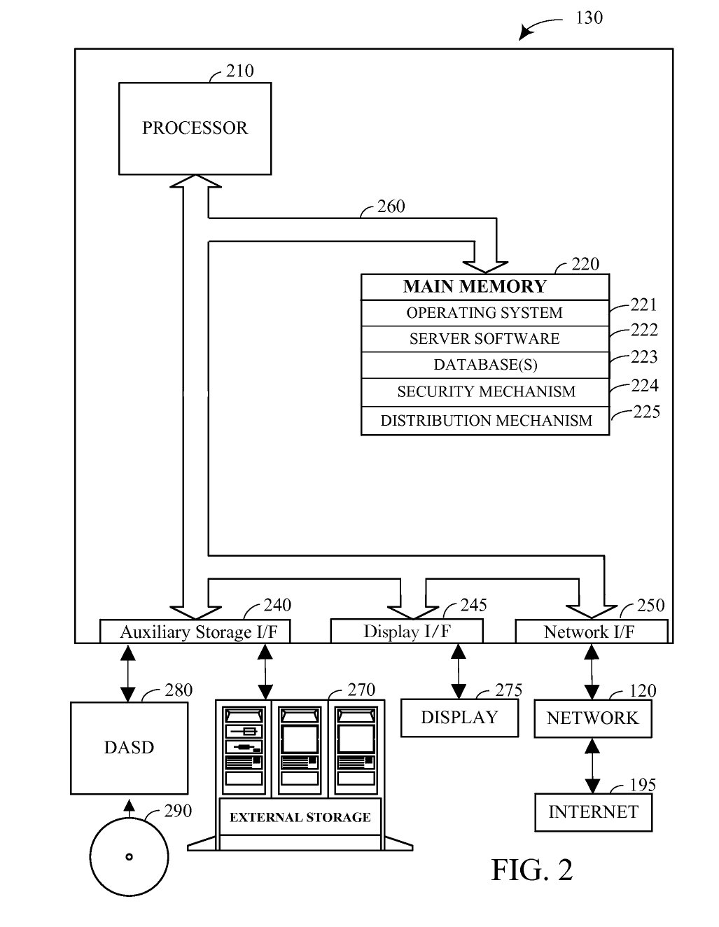

Referring now to FIG. 2, digital media server 130 of FIG. 1 in accordance with a preferred embodiment of the present invention represents one of many commercially available computer systems such as a Linux®-based computer system, an IBM® compatible computer system, or a Macintosh® computer system. However, those skilled in the art will appreciate that the methods and system of the present invention apply equally to any computer system, regardless of the specific operating system and regardless of whether the computer system is a more traditional “mainframe” computer, a complicated multi-user computing device or a single user device such as a personal computer or workstation.

Digital media server 130 suitably comprises at least one central processing unit (“CPU”) or processor 210, an auxiliary storage interface 240, a display interface 245, and a network interface 250, all of which are interconnected via a system bus 260. Note that various modifications, additions, or deletions may be made to digital media server 130 illustrated in FIG. 2 within the scope of the present invention such as the addition of cache memory or other peripheral devices. FIG. 2 is not intended to be exhaustive, but is presented to simply illustrate some of the more salient features of digital media server 130.

Processor 210 performs computation and control functions of digital media server 130, and most preferably comprises a suitable CPU. Processor 210 may comprise a single integrated circuit, such as a microprocessor, or may comprise any suitable number of integrated circuit devices and/or circuit boards working in cooperation to accomplish the functions of a processor or CPU. Processor 210 is configured to execute one or more software programs contained within main memory 220. Although digital media server 130 depicted in FIG. 2 contains only a single main processor 210 and a single system bus 260, it should be understood that the present invention applies equally to computer systems having multiple processors and multiple system buses. Similarly, although system bus 260 of the preferred embodiment is a typical hardwired, multi-drop bus, any connection means that supports bi-directional communication in a computer-related environment could be used.

Auxiliary storage interface 240 allows digital media server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disk 290.

Display interface 245 is used to directly connect one or more displays 275 to digital media server 130. Display 275, which may be a video monitor is used to provide system administrators and users the ability to view information related to the operation of digital media server 130. Note, however, that while display interface 245 is provided to support communication with one or more displays 275, digital media server 130 does not necessarily require a display 275, because all needed interaction with users and other processes may occur via network 120. Additionally, in certain preferred embodiments, digital media server 130 may have an integrated display 275.

Network interface 250 is used to connect digital media server 130 to network 120 and digital media distribution system 100 of FIG. 1. Network interface 250 broadly represents any suitable way to interconnect electronic devices, regardless of whether the network comprises present day analog and/or digital techniques or via some networking mechanism of the future. Network interface 250 preferably includes a combination of hardware and software that allows communications on network 120.

Software provided in conjunction network interface 250 preferably includes a communication manager that manages communication with other computer systems or other network devices via network 120 using a suitable network protocol. Many different network protocols can be used to implement a network. These protocols are specialized computer programs that allow computers to communicate across a network. TCP/IP (Transmission Control Protocol/Internet Protocol) is just one example of a suitable network protocol that may be used by the communication manager contained within network interface 250.

Main memory 220 suitably contains an operating system 221, server software 222, one or more databases 223, a security mechanism 224, and a digital media distribution mechanism 225. The term “memory” as used herein refers to any storage location in the virtual memory space of digital media server 130. It should be understood that main memory 220 might not necessarily contain all parts of all components shown.

For example, portions of operating system 221 may be loaded into an instruction cache (not shown) for processor 210 to execute, while other files may well be stored on external magnetic or optical disk storage devices (not shown). In addition, although database 223 is shown to reside in the same memory location as operating system 221, it is to be understood that main memory 220 may consist of multiple disparate memory locations. It should also be noted that any and all of the individual software mechanisms or components shown in main memory 220 might be combined in various forms and distributed as a stand-alone program product. Finally, it should be noted that additional software components, not shown in this figure, might also be included.

Operating system 221 includes the software that is used to operate and control digital media server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with graphical user interface 224, including via network 120 of FIG. 1.

Database 223 is representative of any suitable database known to those skilled in the art. In the most preferred embodiments of the present invention, database 223 stores media files that may be of interest to the users of digital media distribution system 100 of FIG. 1. In the most preferred embodiments of the present invention, database 223 will comprise a plurality of media files in various formats, including digital music files (including music video files), digital books and other textually based media, and other audio/video media files including TV shows and movies all to be distributed via system 100 of FIG. 1.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 might also be physically stored in a location other than main memory 220. For example, database 223 may be stored on external storage device 270 or DASD 280 and coupled to digital media server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

In addition, most preferred embodiments of the present invention would include a security and/or encryption mechanism 224 for verifying access to the data and information contained in and transmitted to and from digital media server 130. Security mechanism 224 may be incorporated into operating system 221 and/or web server 222. Additionally, security mechanism 224 may also provide encryption capabilities for other components of digital media distribution system 100 of FIG. 1, thereby enhancing the robustness of digital media distribution system 100 of FIG. 1. Security mechanism 224 is most preferably configured to protect the integrity and security of the media files and related information during transmission,

Further, depending on the type and quantity of information stored in database 223, security mechanism 224 may provide different levels of security and/or encryption for the information stored in database 223. The level and type of security measures applied by security mechanism 224 may be determined by the identity of the end-user and/or the nature of a given request and/or response. In some preferred embodiments of the present invention, security mechanism 224 may be contained in or implemented in conjunction with certain hardware components (not shown this FIG.) such as hardware-based firewalls, switches, dongles, and the like.

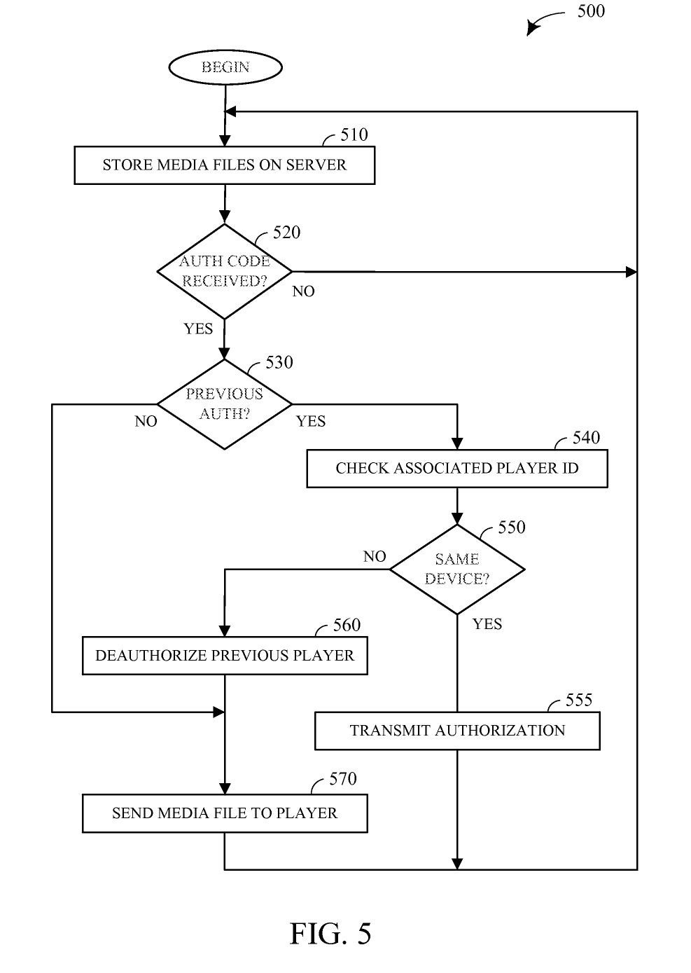

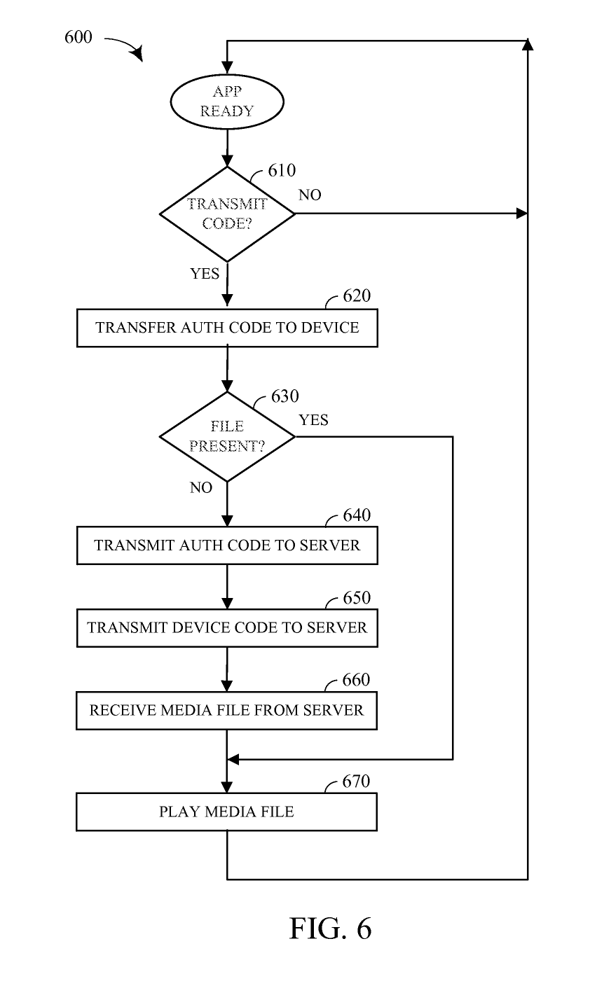

Digital media distribution mechanism 225 is a software program that controls the authorization and distribution of the digital media files that are distributed from server 130. Digital media distribution mechanism 225 works in tandem with the app loaded on digital media player 190 of FIG. 1 to ensure that the appropriate digital media files are provided for requesting users. Additional details about the operational methodology of digital media distribution mechanism 225 are presented below in conjunction with FIG. 5 and FIG. 6.

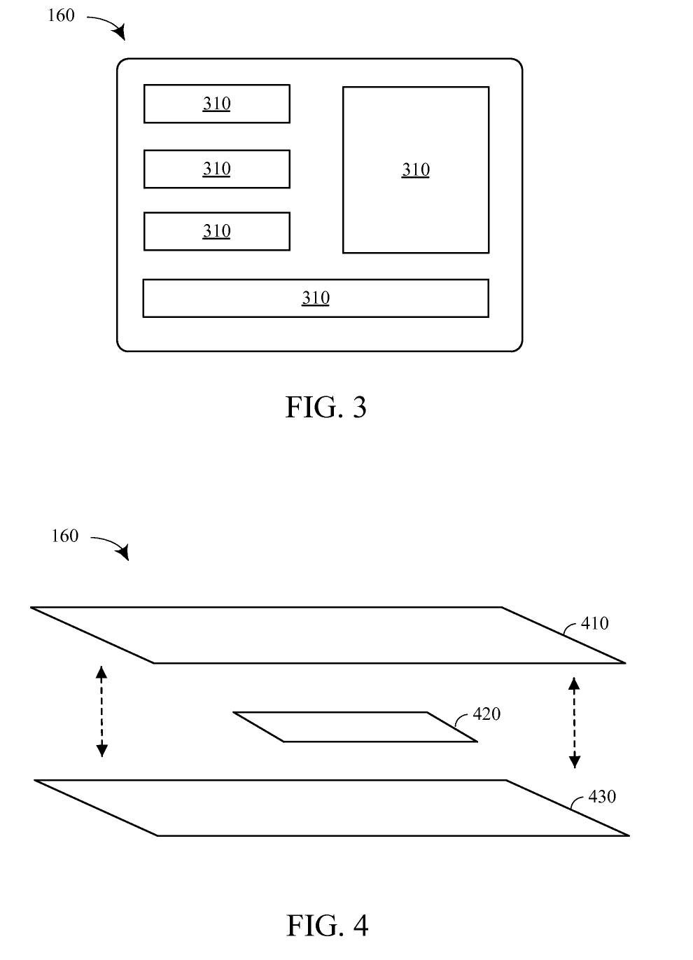

Referring now to FIG. 3 is a block diagram illustrating a physical authorization device 160 for use in conjunction with a digital media distribution system for providing digital media downloads in accordance with a preferred exemplary embodiment of the present invention. As shown in FIG. 3 and FIG. 4, physical authorization device 160 is most preferably a card-like device that comprises a plurality of identifying indicia 310. Indicia 310 may be printed on the front and the back of physical authorization device 160. Identifying indicia 310 typically includes information such as artist or author name, photos, lyrics, explanatory materials, advertising, ratings and reviews. Identifying indicia 310 may contain other materials, similar to the album cover art found on a CD or a dust jacket for a book or other information that may include graphic and/or textual material. Although there are no specific minimum or maximum size requirements, in the most preferred embodiments of the present invention, physical authorization device 160 will be a credit card size device or some other size that is easy to handle and distribute.

Referring now to FIG. 4, an exploded view of physical authorization device 160 of FIG. 1 for use in conjunction with a digital media distribution system for providing digital media downloads in accordance with a preferred exemplary embodiment of the present invention is depicted. As shown in FIG. 4, physical authorization device 160 comprises a top layer 410 and a bottom layer 430 with an NFC circuit 420 sandwiched in between the two layers. In the most preferred embodiments of the present invention, physical authorization device 160 is manufactured from an inexpensive material that is easy to print on and that is readily permeable for NFC signal transmission. Stiff card stock and other similar materials may be used with good results.

Referring now to FIG. 5 a flowchart 500 for a method of distributing digital media files from a digital media server to a digital media player in accordance with a preferred exemplary embodiment of the present invention is depicted. As shown in FIG. 5, a plurality of media files will be stored on digital media server 130 of FIG. 2. Digital media distribution mechanism 225 of FIG. 2 will remain in a “wait” state (step 510=“NO”) until an appropriate reusable media authorization code is received. Digital media distribution mechanism 225 will be alerted any time a valid reusable media authorization code is received from a digital media player such as digital media player 190 of FIG. 1 (step 520=“YES”).

Once a proper authorization request has been received, digital media distribution mechanism 225 will determine the status of the requested digital media file. If the digital media file associated with the reusable media authorization code has not previously been authorized for a given digital media player (step 530=“NO”), then digital media distribution mechanism 225 will transfer the requested digital media file to the requesting digital media player (step 570).

However, if the digital media file associated with the reusable media authorization code has previously been authorized for a given digital media player (step 530=“YES”), then digital media distribution mechanism 225 will check the player or device identification associated with the reusable media authorization code (step 540) to determine the identity of the digital media player. If the device identification confirms that the device is currently authorized for the requested digital media file, (step 550=“YES”) then digital media distribution mechanism 225 will forward an reusable media authorization code to the requesting digital media player and no additional steps are needed because the requested digital media file is already on the requesting digital media player and, upon receipt of the authorization from digital media distribution mechanism 225, the user may then access the digital media file on the requesting digital media player.

However, if the requesting digital media player is not the same digital media player that had been previously authorized to access the requested digital media file (step 550=“NO”), then digital media distribution mechanism 225 will first transmit a media de-authorization code to the app that resides on the previously authorized digital media player (step 560) and then transmit the requested digital media file (step 570) to the most recently requesting digital media player as identified by the most recently received reusable media authorization code.

Referring now to FIG. 6, a flowchart 600 for a method of requesting and receiving digital media files from a digital media server for use in conjunction with a digital media player in accordance with a preferred exemplary embodiment of the present invention is depicted. As shown in FIG. 6, an application on digital media player, such as digital media player 190 of FIG. 1, is used to initiate the process of accessing a digital media file. The app on digital media player 190 will remain in a “wait” state (step 610=“NO”) until a physical authorization device is used to activate the app. Once a user signals digital media player 190 to initiate the transmission of the reusable media authorization code associated with the physical authorization device (e.g., taps or contacts a physical authorization device on digital media player 190, uses the app to scan a Quick Response (“QR”) code containing the reusable media authorization code, or manually enter the reusable media authorization code into the app interface) (step 610=“YES”), the app will first receive the reusable media authorization code from the digital media player (step 620). If the corresponding media file for the reusable media authorization code is already present on digital media player 190 (step 630=“YES”), then the app will load and provide user access to the digital media file so that the user can play or display the media file (step 670).

If the digital media file is not already stored on digital media player 190 (step 630=“NO”), then digital media player 190 will transmit the reusable media authorization code and the device authorization code to digital media server 130 (step 640 and step 650). After authentication from digital media server 130 has been completed, digital media player 190 will receive the digital media file from digital media server 130 (step 660) and the app will provide user access to the digital media file so that the user can play or display the media file (step 670).

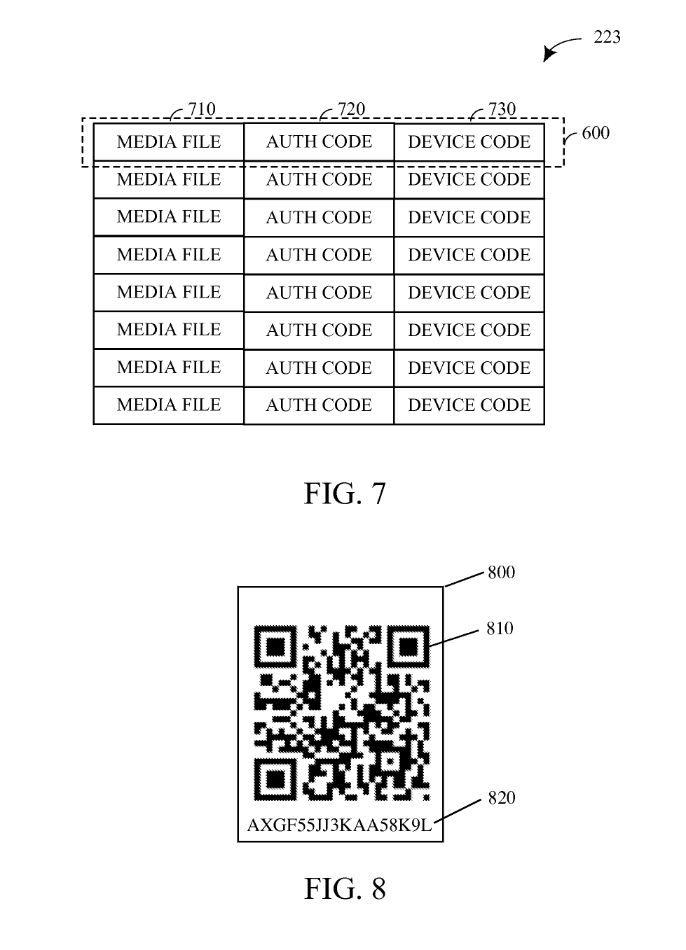

Referring now to FIG. 7, a block diagram of a collection of media files stored in database 223 on digital media server 130 of FIG. 2 for delivery to one or more digital media players in accordance with a preferred exemplary embodiment of the present invention is depicted. As shown in FIG. 7, a plurality of digital media files 710 are stored in database 223. Each of digital media files 710 comprises at least a reusable media authorization code 720 and a device authorization code 730. Upon receipt of a request for a given media file 710, the application software on digital media server 130 can use the associated reusable media authorization code 720 to locate and then transfer the requested media file to the requesting digital media player. Additionally, the use of a device authorization code 720 will ensure that the requested media file 710 is authorized for use only in conjunction with a single digital media player at a time.

Referring now to FIG. 8, an alternative embodiment of the present invention is depicted. Those skilled in the art will understand and recognize that not all digital media players are presently equipped with NFC capabilities. Accordingly, in order to accommodate more potential consumers, other reusable media authorization code recognition methods may be adopted in addition to or instead of the NFC embodiments described herein.

For example, as shown in FIG. 8, a sticker 800, bearing a QR code 810 and a reusable media authorization code 820 may be affixed to an authorization device in addition to or in place of the NFC circuit 420 previously described in conjunction with FIG. 4. In the case of QR code 810, the required reusable media authorization code to download the media file associated with the authorization device may be embedded in QR code 810 and extracted by the digital media app.

Similarly, the required reusable media authorization code to download the media file associated with the authorization device may be simply printed on sticker 800 and affixed to the authorization device. Those skilled in the art will recognize that the use of an eye-legible indicia bearing reusable media authorization code 820 will require that reusable media authorization code 820 be hidden from view until after the consumer has purchased the authorization device bearing reusable media authorization code 820. After launching the app on the digital media player, the consumer will be prompted to scan QR code 810 or manually enter reusable media authorization code 820 into the user interface. Once the digital media player has captured the reusable media authorization code, the correct digital media file can be accessed using the methods previously described in FIG. 5 and FIG. 6.

While authorization to access one more digital media files may be accomplished by any of the methods described herein, the actual authorization method(s) will be largely dependent on market considerations such as market penetration, cost, etc. Those skilled in the art will appreciate that the use of reusable media authorization codes as described herein is different than previously adopted gift card redemptions. For example, instead of being redeemable for only a single user, or a single purchase, the reusable media authorization code deployment and use methods associated with the authorization device of the present invention will allow multiple users to access digital media files over and over again. Digital authorization devices can be collected, bought, sold, traded, etc. while ensuring that only one digital media player can access the associated digital media file(s). This will reduce the opportunity and motivation for piracy and ensure that the creators and distributors of digital media are able to recover the desired compensation for their efforts.

From the foregoing description, it should be appreciated that system and method for event tracking and messaging disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A computer-based system for accessing digital media files comprising:
a digital media server, the digital media server comprising:
a plurality of digital files;
at least one device authorization code; and
a reusable media authorization code operating independently of user authentication information;
an authorization device, the authorization device authenticating a first digital media player to access at least one of the plurality of digital media files stored on the digital media server, wherein at least one of the plurality of digital media files is downloaded and accessed by the first digital media player after authentication by the at least one device authorization code when the reusable media authorization code is provided by at least one of:
an NFC circuit associated with the authorization device, the NFC circuit being configured to transmit the re-useable media authorization code to the digital media player upon contact with the digital media player, thereby enabling the digital media player to access a specific digital media file associated with the reusable media authorization code from the plurality of digital media files stored on the digital media server; or
a QR code containing the reusable media authorization code associated with the authorization device, the first digital media player being configured to extract the re-useable media authorization code from the QR code, thereby enabling the first digital media player to access a specific digital media file associated with the reusable media authorization code from the plurality of digital media files stored on the digital media server; or
an eye-legible reusable media authorization code affixed to a surface of the authorization device, wherein a user inputs the reusable media authorization code into the first digital media player, thereby enabling the first digital media player to access a specific digital media file associated with the re-useable media authorization code from the plurality of digital media files stored on the digital media server; and
wherein the authorization device authenticates the first digital media player and provides access to the least one of the plurality of digital media files by the first digital media player using at the at least the device authorization code and the reusable media authorization code after a successful first time authentication.

2. The computer-based system of claim 1 wherein the specific digital media file comprises at least one of: a digitized song; a digitized book; a digitized movie; a collection of digitized songs; and a digitized magazine.

3. The computer-based system of claim 1 further comprising a device authorization code received from the first digital media player, the device authorization code being used to authenticate the first digital media player prior to allowing the first digital media player access the specific digital media file.

4. The computer-based system of claim 1 further comprising a second digital media player, the second digital media player being authorized to access the specific digital media file based upon a device authorization code and the reusable media authorization code and the first digital media player being unauthorized to access the specific digital media file based upon a device authorization code and the reusable media authorization code.

5. The computer-based system of claim 1 wherein the QR code and the eye-legible reusable media authorization code are printed on a sticker affixed to a surface of the authorization device.

6. The computer-based system of claim 1 wherein the authorization device comprises a plurality of indicia, the indicia describing the specific media file associated with the reusable media authorization code associated with the authorization device.

7. The computer-based system of claim 1 wherein the authorization device comprises a card, the card comprising:
a top surface;
a bottom surface;
an NFC circuit positioned between the top surface and the bottom surface, the NFC circuit being configured to transmit the reusable media authorization code from the authorization device to the first digital media player; and
a sticker affixed to the top surface or the bottom surface, the sticker comprising:
a QR code, wherein the reusable media authorization code is embedded in the QR code; and
an eye-legible version of the reusable media authorization code printed on the sticker.

8. The computer-based system of claim 1 wherein the first digital media player comprises an application stored in a memory location of the digital media player, the application transmitting the reusable media authorization code and a device authorization code from the digital media player to the digital media server, thereby authorizing the digital media player to access the specific media file.

9. The computer-based system of claim 1 further comprising a security mechanism and a distribution mechanism on the digital media server.

10. A method for accessing digital media files comprising the steps of:
storing a plurality of digital media files on a digital media server, the digital media server comprising;
a plurality of digital media files;
at least one device authorization code;
and a reusable media authorization code configured to operate independent of user information;
receiving the reusable media authorization code from a first digital media player, the reusable media authorization code being provided to the first digital media player from an authorization device by:
accessing an NFC circuit associated with the authorization device, the NFC circuit being configured to transmit the re-useable authorization code to the digital media player upon contact with the digital media player, thereby enabling the digital media player to access a specific digital media file associated with the re-useable media authorization code from the plurality of digital media files stored on the digital media server;
scanning a QR code containing the reusable media authorization code associated with the authorization device, the digital media player being configured to extract the re-useable media authorization code from the QR code, thereby enabling the digital media player to access a specific digital media file associated with the reusable media authorization code from the plurality of digital media files stored on the digital media server; and
reading an eye-legible encrypted reusable media authorization code affixed to a surface of the authorization device, wherein a user inputs the reusable media authorization code into the digital media player, thereby enabling the digital media player to access a specific digital media file associated with the re-useable media authorization code from the plurality of digital media files stored on the digital media server; and
transmitting the specific digital media file to the first digital media player based upon the media authorization code, wherein the authorization device controls access to the specific digital media file by authenticating the first digital media player using the at least one device authorization code and the reusable media authorization code after a successful first time authentication.

11. The method of claim 10 further comprising the steps of:
receiving a device authorization code from the first digital media player;
transmitting the specific digital media file to the first digital media player based upon the device authorization code and the media authorization code.

12. The method of claim 11 wherein the specific digital media file comprises at least one of:
a digitized song;
a digitized book; a digitized movie;
a collection of digitized songs; and
a digitized magazine.

13. The method of claim 12 further comprising the step of de-authorizing a second digital media player based upon the device authorization code and the media authorization code.

14. The method of claim 13 further comprising the step of erasing at least one digital media file from at least one of the first digital media player or the second digital media player based upon the device authorization code and the media authorization code.

15. The method of claim 13 wherein the QR code and the eye-legible reusable media authorization code are printed on a sticker affixed to a surface of the authorization device.

16. The method of claim 10 wherein the authorization device comprises a plurality of indicia, the indicia describing the specific media file associated with the reusable media authorization code associated with the authorization device.

17. The method of claim 10 wherein the steps of reusable media authorization code and transmitting the specific digital media file to the first digital media player based upon the media authorization code are performed by a distribution mechanism residing in a computer memory residing in the digital media server.

18. A physical authorization device, the physical authorization device comprising a card, the physical authorization device further comprising:
a reusable media authorization code operating independently of user information, the reusable media authorization code being accessible by the at least one digital media player using a method including at least one of:
contacting the digital media player with the authorization device, thereby activating an NFC circuit to transmit the re-useable media authorization code to the digital media player, thereby authorizing the digital media player to access a specific digital media file associated with the re-useable media authorization code;
scanning a QR Code with an application stored on the digital media player and extracting the re-useable media authorization code thereby authorizing the digital media player to access a specific digital media file associated with the re-useable media authorization code; and
entering the re-useable media authorization code for input into an application interface displayed on the digital media player, thereby authorizing the digital media player to access a specific digital media file associated with the re-useable media authorization code; and
eye-legible indicia describing the contents of the specific digital media file associated with the re-useable media authorization code of the authorization device.

19. The physical authorization device of claim 18 wherein the specific digital media file comprises at least one of: a digitized song; a digitized book; a digitized movie; a collection of digitized songs; and a digitized magazine.

20. The physical authorization device of claim 18 wherein the physical authorization device further comprises a re-useable media authorization code accessible by each of:
an NFC circuit associated with the authorization device, the NFC circuit being configured to transmit the re-useable media authorization code to the digital media player upon contact with the digital media player, thereby enabling the digital media player to access a specific digital media file associated with the reuseable media authorization code; and
a QR code containing the reusable media authorization code associated with the authorization device, the digital media player being configured to extract the reusable media authorization code from the QR code, thereby enabling the digital media player to access a specific digital media file associated with the re-useable media authorization code; and
an eye-legible reusable media authorization code affixed to a surface of the authorization device, wherein a user inputs the reusable media authorization code into the digital media player, thereby enabling the digital media player to access a specific digital media file associated with the re-useable media authorization code.
